(19) United States
(12) Patent Application Publication
(10) Pub. No.: US 2011/0090678 A1
(43) Pub. Date: Apr. 21, 2011

(54) Street light with continuous supply of light

(76) Inventor: Raymond Saluccio, Colonia, NJ (US)

(21) Appl. No.: 12/589,149

(22) Filed: Oct. 19, 2009

(51) Int. Cl. F21L 4/00

(52) U.S. Cl. 362/183

(57) ABSTRACT

The present invention provides an energy efficient street light, having a pole support and a light fixture mounted on the pole support. A first light receiving lens is located on the upper area of the light fixture for receiving natural light during day light hours. A second light receiving lens is located on the bottom area of the light fixture for receiving light from the light fixture when it is turned on at night. A plurality of solar panels are disposed in an enclosure above ground, or in an enclosure below ground. A plurality of light transmitting fiber optic cables are connected to the first and second light receiving lenses for transmitting light (natural and from the light fixture) to the plurality of solar panels 24 hours a day for storing the light energy to power the light fixture on one or more street lights. One or more electric cables are provided for transmitting electricity from the solar panels to one or more light fixtures.

Alternatively, one or more electric cables are provided for transmitting electricity from the solar panels to an electric grid for providing electricity to the grid.

### FIELD OF THE INVENTION

This invention relates to collecting electricity from streetlights and storing it in solar panels, and the stored electricity can be used to power one or more streetlights, or alternatively, the stored electricity can be transmitted to an electric power grid for providing electricity to the grid.

### BACKGROUND OF THE INVENTION

Common street lights are located in every city, and provide a tremendous amount of light energy that can be utilized as a source of energy. For example, it would be desirable to try and collect such wasted light energy from street lights, which goes unused, and recycle such electric energy to electric grids, where the electric energy can be used to supply electricity for other uses.

### OBJECTS OF THE PRESENT INVENTION

It is an object of the present invention to collect electricity from streetlights and store it in solar panels, and the stored electricity can be used to power one or more streetlights, or alternatively, the stored electricity can be transmitted to an electric power grid for providing electricity to the grid.

### SUMMARY OF THE INVENTION

The present invention provides an energy efficient street light, having a pole support and a light fixture mounted on the pole support. A first light receiving lens is located on the upper area of the light fixture for receiving natural light during day light hours. A second light receiving lens is located on the bottom area of the light fixture for receiving light from the light fixture when it is turned on at night. A plurality of solar panels are disposed in an enclosure above ground, or in an enclosure below ground. A plurality of light transmitting fiber optic cables are connected to the first and second light receiving lenses for transmitting light (natural and from the light fixture) to the plurality of solar panels 24 hours a day for storing the light energy to power the light fixture on one or more street lights. One or more electric cables are provided for transmitting electricity from the solar panels to one or more light fixtures.

Alternatively, one or more electric cables are provided for transmitting electricity from the solar panels to an electric grid for providing electricity to the grid.

### BRIEF DESCRIPTION OF THE DRAWINGS

FIG. 1 is a diagrammatic view of a streetlight for collecting light energy and using it to power the light fixture, or to transmit the light energy to an electric power grid.

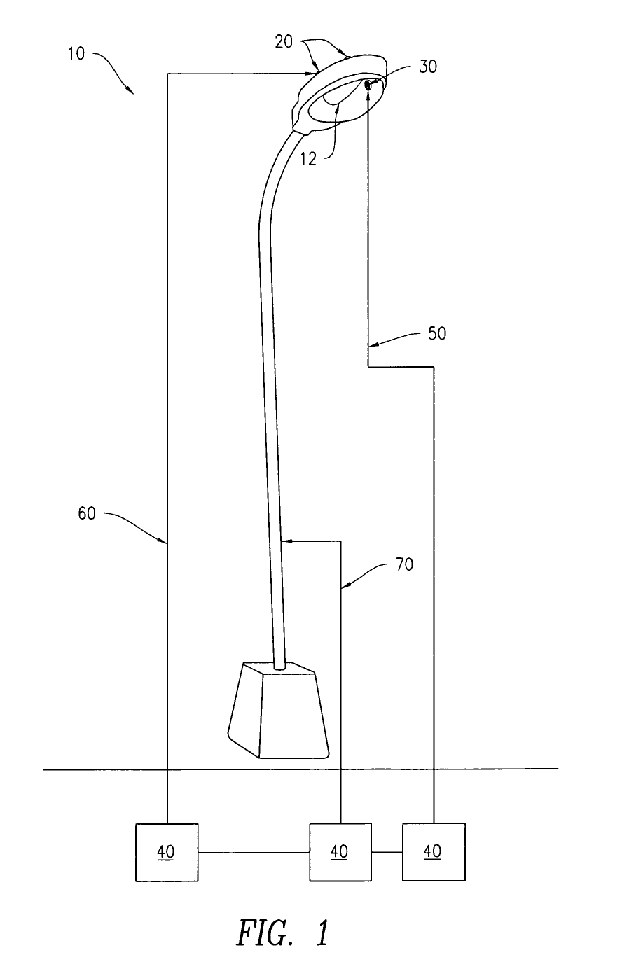

FIG. 2 is a bottom view of the street lamp showing three lenses 30 located on the bottom area of the light fixture 16b for receiving light from the light fixture 16 when it is turned on at night.

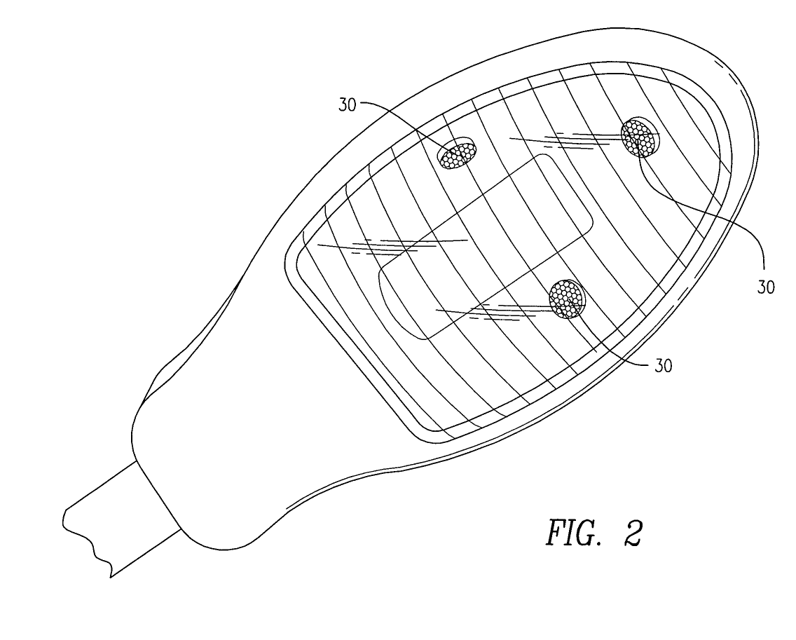

FIG. 3 is a top view of the street lamp showing eight lenses 20 located on the upper area 16a of the light fixture 16 for receiving natural light during day light hours.

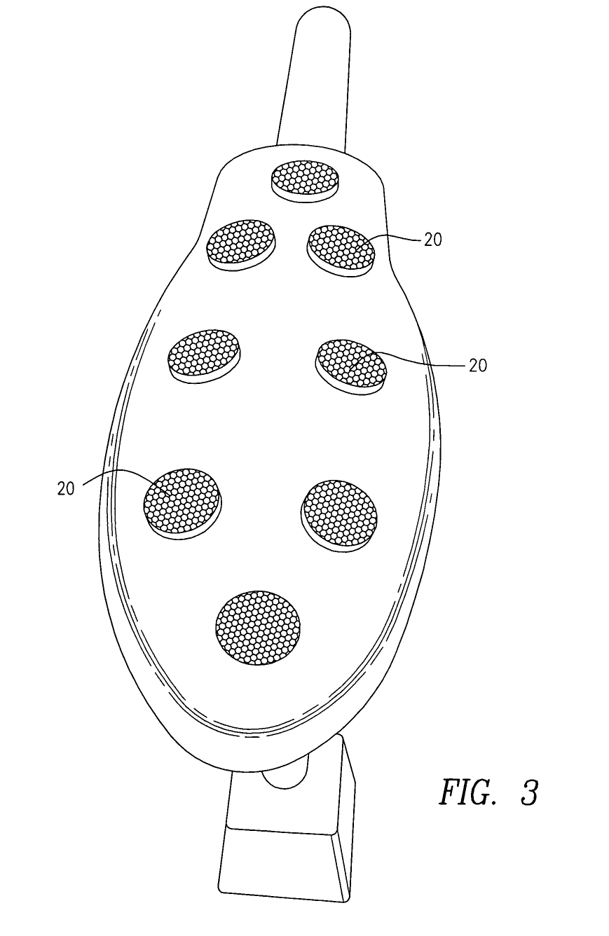

### DETAILED DESCRIPTION OF THE PREFERRED EMBODIMENT

The present invention provides an energy efficient street light 10, having a pole support 14 and a light fixture 16 having a bulb 12 mounted on the pole support 14. A first light receiving lens 20 is located on the upper area 16a of the light fixture 16 for receiving natural light during day light hours. A second light receiving lens 30 is located on the bottom area of the light fixture 16b for receiving light from the light fixture 16 when it is turned on at night. A plurality of solar panels 40 are disposed in an enclosure 50 above ground, or in an enclosure 60 below ground. A plurality of light transmitting fiber optic cables 70 are connected to the first and second light receiving lenses 20 and 30 for transmitting light (natural and from the light fixture) to the plurality of solar panels 40 twenty four hours a day for storing the light energy to power the light fixture 16 on one or more street lights. One or more electric cables 80 are provided for transmitting electricity from the solar panels 40 to one or more light fixtures.

Alternatively, one or more electric cables 90 are provided for transmitting electricity from the solar panels 40 to an electric power grid 100 for providing electricity to the grid.

### ADVANTAGES OF THE PRESENT INVENTION

The present invention provides the advantage of collecting electricity from streetlights and storing it in solar panels, and the stored electricity is used to power one or more streetlights, or alternatively, the stored electricity is transmitted to an electric power grid for providing electricity to the power grid.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1) An energy efficient street light, having a pole support and a light fixture mounted on the pole support, comprising:
a) a first light receiving lens on the upper area of the light fixture for receiving natural light during day light hours;
b) a second light receiving lens on the bottom area of the light fixture for receiving light from the light fixture when it is turned on at night;
c) a plurality of solar panels disposed in an enclosure above ground, or in an enclosure below ground;
d) a plurality of light transmitting fiber optic cables connected to said first and second light receiving lenses for transmitting light (natural and from the light fixture) to said plurality of solar panels 24 hours a day for storing said light energy to power said light fixture on one or more street lights; and
e) one or more electric cables for transmitting electricity from said solar panels to one or more light fixtures.
